(19) United States
(12) Patent Application Publication
(10) Pub. No.: US 2004/0080140 A1
(43) Pub. Date: Apr. 29, 2004

(54) Interchangeable pintle hook and ball mount for steel bed truck

(76) Inventor: Robert Benjamin Hart, Front Royal, VA (US)

Correspondence Address: Dodds & Associates, 1707 N Street NW, Washington, DC, 20036, US

(21) Appl. No.: 10/065,550

(22) Filed: Oct. 29, 2002

(51) Int. Cl. B60D 1/07

(52) U.S. Cl. 280/416.1

(57) ABSTRACT

Tow connection system for use with a vehicle having a steel bed. The tow connection system includes a mounting assembly rigidly coupled to the steel bed and interchangeable pintle hook and hitch ball assemblies that can be releasably coupled to the mounting assembly via a locking pin.

### BACKGROUND OF INVENTION

1. Field of the Invention

The present invention relates generally to hitch systems for pulling trailers behind vehicles. In another aspect, the invention relates to combination pintle hook and hitch ball assemblies that allow a vehicle to tow trailers having either an O-ring type hitch or a socket type hitch.

2. Description of the Prior Art

A variety of pintle hook ball mounts are commonly available and provide the advantage of being able to couple either an O-ring type hitch or a socket type hitch to a vehicle using the same pintle hook ball mount. One disadvantage of conventional pintle hook ball mounts is that the hitch ball is extremely difficult to remove and typically requires use of an expensive impact wrench to decouple the hitch ball from the pintle hook ball mount. Thus, if the owner of the vehicle equipped with the pintle hook ball mount does not have an impact wrench, the owner must take the pintle hook ball mount to someone who owns an impact wrench every time the hitch ball needs to be changed to accommodate a different trailer having a different size socket hitch. Obviously, this can be a very time consuming and expensive undertaking.

Most conventional pintle hook ball mounts are configured to be coupled to the rear of a truck having a steel bed. Typically, the coupling of the conventional pintle hook ball mount to the steel bed is accomplished using four bolts that are extended through four holes in the pintle hook ball mount and a corresponding four holes defined in a generally vertical rear face of the steel bed. Because the bolts coupling the pintle hook ball mount to the steel bed must be extremely tight to allow the pintle hook ball mount to pull heavy loads, these bolts typically cannot be removed without the use of an impact wrench. Thus, if the owner of the vehicle equipped with the conventional pintle hook ball mount does not own an impact wrench, the owner must take the vehicle to someone who owns an impact wrench every time a different size pintle hook ball mount is required to accommodate a trailer having a different size or configuration of hitch. Obviously, this can be a very time consuming and expensive undertaking.

### SUMMARY OF INVENTION

Responsive to these and other problems, it is an object of the present invention to provide a system for easily changing pintle hook and hitch ball assemblies on vehicles having steel beds. Further objects and advantages of the invention will be apparent from the drawings, detailed description of the preferred embodiment, and appended claims.

Accordingly, in one embodiment of the present invention, there is provided a tow connection system for use with a vehicle having a steel bed. The steel bed presents a substantially vertical rear face defining a plurality of mounting holes for bolting a conventional pintle hook ball mount to the steel bed. The tow connection system comprises a baseplate, a receiver tube, a first pintle hook and hitch ball assembly, a second pintle hook and hitch ball assembly, and an elongated pin. The baseplate defines a plurality of openings configured to be aligned with the mounting holes in the steel bed. The receiver tube presents proximal and distal ends. The proximal end of the receiver tube is rigidly coupled to the baseplate. The receiver tube defines a receiver channel extending inwardly from the distal end. The first pintle hook and hitch ball assembly includes a first coupling member of a first size and a first attachment bar adapted to be slidably and snugly received in the receiver channel. The second pintle hook and hitch ball assembly includes a second coupling member of a second size and a second attachment bar adapted to be slidably and snugly received in the receiver channel. The tow connection system is shiftable between a first position wherein the first attachment bar is secured to the receiver tube with the pin and a second position wherein the second attachment bar is secured to the receiver tube with the pin.

In accordance with another embodiment of the present invention, there is provided an apparatus comprising a vehicle, a mounting assembly, a first pintle hook and hitch ball assembly, and an elongated pin. The vehicle has a steel bed presenting a substantially vertical rear face defining at least four mounting holes. The mounting assembly includes a baseplate, a receiver tube, and at least four bolts. The baseplate defines at least four baseplate holes aligned with the four mounting holes in the steel bed. Each of the bolts extends through a respective aligned mounting hole and baseplate hole and rigidly couples the mounting assembly to the rear face of the steel bed. The receiver tube includes a proximal end rigidly coupled to the baseplate and a distal end spaced from the baseplate. The receiver tube defines a receiver channel extending inwardly from the distal end. The first pintle hook and hitch ball assembly includes a first coupling member and a first attachment bar adapted to be slidably and snugly received in the receiver channel. The first pintle hook and hitch ball assembly is shiftable between a first decoupled position wherein the first pintle hook and hitch ball assembly is decoupled from the mounting assembly and first coupled position wherein a first attachment bar is received in the receiver channel and the locking pin extends through the receiver tube and the first attachment bar.

In accordance with a further embodiment of the present invention, there is provided a method of changing pintle hook and hitch ball assemblies on a vehicle. The method comprises the steps of: (a) removing a first pintle hook and hitch ball assembly from a receiver tube rigidly coupled to a steel bed of the vehicle; (b) inserting a second pintle hook and hitch ball assembly into the receiver tube; and (c) extending a pin through the second pintle hook and hitch ball assembly and the receiver tube, thereby securing the second pintle hook and hitch ball assembly in the receiver tube.

### BRIEF DESCRIPTION OF DRAWINGS

A preferred embodiment of the present invention is described in detail below with reference to the attached drawing figures, wherein:

FIG. 1 is a perspective view of a vehicle having a steel bed, particularly illustrating an inventive tow connection system being attached to a rear face of the steel bed; and

FIG. 2 is an enlarged perspective assembly view of the tow connection system, particularly illustrating the manner in which the mounting assembly is coupled to the rear face of the steel bed and the manner in which first and second pintle hook and hitch ball assemblies can be interchangeably coupled to the mounting assembly.

### DETAILED DESCRIPTION

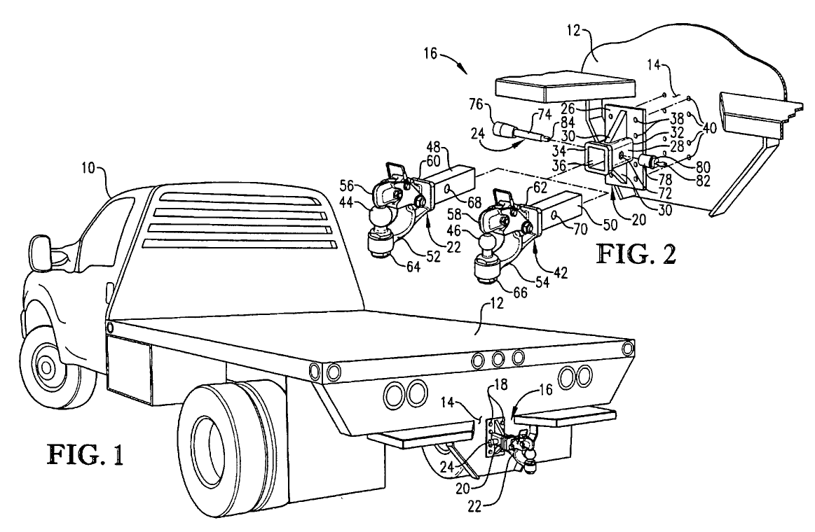

Referring initially to FIG. 1, a vehicle 10 is illustrated as being equipped with a conventional steel bed 12. Steel bed 12 presents a substantially vertical rear face 14 to which a tow connection system 16 can be coupled via bolts 18. Tow connection system 16 generally includes a mounting assembly 20 and a pintle hook and hitch ball assembly 22. Mounting assembly 20 is rigidly coupled to rear face 14 of steel bed 12 via bolts 18. Pintle hook and hitch ball assembly 22 is adapted to be releasably coupled to mounting assembly 20 via a locking pin 24. Pintle hook and hitch ball assembly 22 can be any of a variety of commercially available combination pintle hook and hitch ball devices known in the art. For example, one suitable pintle hook and hitch ball assembly is sold under the commercial designation “2″ Ball and Pintle Hook, PN 4203,” available from Draw-Tight, Inc., Canton, Mich.

Referring to FIG. 2, mounting assembly 20 generally includes a substantially flat baseplate 26, a generally tubular receiver tube 28, and a plurality of gussets 30. Receiver tube 28 includes a proximal end 32 that is rigidly coupled to baseplate 26 and a distal end 34 that is spaced from baseplate 26. Receiver tube 28 defines a receiver channel 36 that extends into receiver tube 28 from distal end 34 of receiver tube 28. Preferably, receiver tube 28 extends generally perpendicular from baseplate 26 so that receiver channel 36 extends along a line that is substantially perpendicular to the plane along which baseplate 26 is defined. Preferably, proximal end 32 of receiver tube 28 is welded to baseplate 26. Gussets 30 are rigidly coupled to baseplate 26 and receiver tube 28 and help support receiver tube 28 on baseplate 26.

Preferably, gussets 30 are substantially triangular in shape and include a first side welded to baseplate 26 and a second side welded to receiver tube 28. It is important that receiver tube 28 and gussets 30 are properly welded to baseplate 26 in order to ensure sufficient strength of mounting assembly 20 under fully-loaded conditions. It is preferred for the welds coupling receiver tube 28 to baseplate 26 and gussets 30 to receiver tube 28 and baseplate 26 to be made with three passes: an initial root pass using TIG wire, a second root pass using MIG wire, and a final cover pass using MIG wire. Further, after formation of the welds, a cooling grace period should be recognized during which the welds are cooled naturally (i.e., without quenching with water or forced air). It has also been discovered that the strength of mounting assembly 20 can be improved by forming an opening through baseplate 26 prior to coupling receiver tube 28 to baseplate 26. Receiver tube 28 can be extended into the, opening in baseplate 26 and then welded to baseplate 26 on both sides of baseplate 26, thereby strengthening the connection between receiver tube 28 and baseplate 26.

Baseplate 26 defines a plurality of baseplate holes 38. Preferably, baseplate holes 38 have a similar pattern to mounting holes 40 defined in rear face 14 of steel bed 12. Thus, baseplate holes 38 can be aligned with mounting holes 40 so that bolts 18 (shown in FIG. 1) can be extended through baseplate holes 38 and mounting holes 40 to thereby rigidly couple mounting assembly 20 to steel bed 12. The pattern of mounting holes 40 on rear face 14 of steel bed 12 is a standard pattern for steel truck beds that allows conventional pintle hook ball mounts having four attachment holes to be attached at various vertical positions by extending four bolts through the conventional pintle hook ball mount and into four of the mounting holes at the desired elevation. Preferably, baseplate 26 defines eight baseplate holes 38 that are configured to be aligned with a standard pattern of mounting holes 40 on rear face 14 of steel bed 12.

Mounting assembly 20 is adapted to releasably receive either first pintle hook and hitch ball assembly 22 or second pintle hook and hitch ball assembly 42. First and second pintle hook and hitch ball assemblies 22, 42 have a substantially similar configuration; however, a first hitch ball 44 of first pintle hook and hitch ball assembly 22 has a substantially greater diameter than a second hitch ball 46 of second pintle hook and hitch ball assembly 42. First and second pintle hook and hitch ball assemblies 22, 42 each include respective first and second attachment bars 48, 50 and first and second coupling members 52, 54. It is preferred for assemblies 22, 42 to be manufactured via welding of attachment bars 48, 50 to coupling members 52, 54. In order to ensure a strong and safe connection between attachment bars 48, 50 and coupling members 52, 54, the ends of attachment bars 48, 50 should be beveled (at least a one half inch (½″) bevel) to provide a sufficiently large surface area for welding attachment bars 48, 50 to coupling members 52, 54. Each of first and second attachment bars 48, 50 is configured to be slidably and snugly received in receiver channel 36. Preferably, first and second attachment bars 48, 50 are generally solid steel bars having a substantially rectangular cross section. First and second coupling members 52, 54 generally include respective first and second locking bars 56, 58, first and second hitch balls 44, 46, and first and second flanges 60, 62. First and second locking bars 56, 58 are adapted to pivot upwardly and away from hitch balls 44, 46 respectively, so that an O-ring type hitch can be placed over hitch balls 44, 46. Once an O-ring type hitch has been placed over hitch balls 44, 46, locking bars 56, 58 can be lowered proximate the top of hitch balls 44, 46 and locked in the closed position so that the O-ring is secured around hitch balls 44, 46. First and second flanges 60, 62 are coupled to an end of respective attachment bars 48, 50. Flanges 60, 62 protrude outwardly from the outer surface of respective attachment bars 48, 50. First and second hitch balls 44, 46 are coupled to respective first and second coupling members 52, 54 via respective first and second ball nuts 64, 66. Ball nuts 64, 66 are extremely tight and typically require an impact wrench to be loosened and tightened.

First and second attachment bars 48, 50 each define respective first and second attachment openings 68, 70. Receiver tube 28 defines a pair of receiver holes 72 that extend through receiver tube 28 and are positioned on generally opposite sides of receiver tube 28. Locking pin 24 is adapted to be extended through receiver holes 72 and either first or second attachment opening 68, 70 when either first or second pintle hook and hitch ball assembly 22, 42 is coupled to mounting assembly 20.

Locking pin 24 generally includes a substantially cylindrical main body 74, a fixed collar 76 rigidly attached to a proximal end of main body 74, and a removable collar 78 adapted to be releasably coupled to a distal end of main body 74. Main body 74 preferably has a generally circular cross section that is configured to be extendable through and snugly received in receiver holes 72, first attachment opening 68, and second attachment opening 70. Removable collar 78 preferably includes a locking mechanism 80 that is actuatable via a key 82. Locking mechanism 80 preferably includes an externally threaded male element that can be threaded into female threads defined in an opening 84 in the distal end of main body 74 when key 82 is received in locking mechanism 80 and locking mechanism 80 and main body 74 are rotated relative to one another. When key 82 is removed from locking mechanism 80, locking mechanism 80 and main body 74 cannot be rotated relative to one another. Thus, locking pin 24 is shiftable between an unlocked position wherein removable collar 78 is decoupled from main body 74 and a locked position wherein removable collar 78 is coupled to main body 74 via threading of locking mechanism 80 into the distal end of main body 74. In order to shift locking pin 24 into or out of the locked position, key 82 must be received in locking mechanism 80, thereby preventing unauthorized unlocking of locking pin 24. A variety of locking pins suitable for use in the present invention are commercially available. For example, one suitable locking, pin is sold under the commercial designation of “Dead-Bolt Receiver Lock, PN 7862,” available from Draw-Tight, Inc., Canton, Mich.

Referring again to FIG. 2, tow connection system 16 can be shifted between a first configuration and a second configuration. When tow connection system 16 is in the first configuration, first pintle hook and hitch ball assembly 22 is coupled to mounting assembly 20 with first attachment bar 48 being received in receiver channel 36, flange 60 engaging distal end 34 of receiver tube 28, main body 74 of locking pin 24 extending through receiver holes 72 and first attachment opening 68, removable collar 78 being coupled to the distal end of main body 74, and key 82 being removed from locking mechanism 80. When tow connection system 16 is in the second configuration, second pintle hook and hitch ball assembly 42 is coupled to mounting assembly 20 with second attachment bar 50 being received in receiver opening 36, second flange 62 engaging distal end 34 of receiver tube 28, main body 74 of locking pin 24 extending through receiver holes 72 and second attachment opening 70, removable collar 78 being coupled to the distal end of main body 74, and key 82 being removed from locking mechanism 80. When tow connection system 16 is in the first configuration, first pintle hook and hitch ball assembly of a first size can be used to tow a trailer having a hitch of a first size/configuration. When tow connection system 16 is in the second configuration, second pintle hook and hitch ball assembly 42 can be used to tow a trailer having a hitch of a second size/configuration.

One advantage of the present invention is that the tow connection system 16 can be readily shifted between the first configuration (wherein first pintle hook and hitch ball assembly 22 is coupled to mounting assembly 20) and the second configuration (wherein second pintle hook and hitch ball assembly 42 is coupled to mounting assembly 20). Tow connection system 16 can be shifted from the first configuration to the second configuration by shifting locking pin 24 from the locked position to the unlocked position, removing main body 74 of locking pin 24 from receiver holes 72 and first attachment opening 68, sliding first attachment bar 48 out of receiver channel 36, sliding second attachment bar 50 into receiver channel 36 until second flange 62 engages distal end 34, extending main body 74 of locking pin 24 through receiver holes 72 and second attachment opening 70, and shifting locking pin 24 into the locked position. Tow connection system 16 can be shifted from the second configuration to the first configuration by shifting locking pin 24 from the locked position to the unlocked position, removing main body 74 of locking pin 24 from receiver holes 72 and second attachment opening 70, sliding second attachment bar 50 out of receiver channel 36, sliding first attachment bar 48 into receiver channel 36 until first flange 60 engages distal end 34 of receiver tube 28, extending main body 74 of locking pin 24 through receiver holes 72 and first attachment openings 68, and shifting locking pin 24 into the locked position. It is preferred for the distances between distal end 34 and receiver holes 72, first flange 60 and first attachment opening 68, and second flange 62 and second attachment opening 70 to be substantially the same, so that when first or second attachment bars 48, 50 is received in receiver channel 36 with respective first or second flanges 60, 62 engaging distal end 34, respective first or second attachment openings 60, 70 are aligned with receiver holes 72.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

1. A tow connection system for use with a vehicle having a steel bed, said steel bed presenting a substantially vertical rear face defining a plurality of mounting holes for bolting a conventional pintle hook ball mount to the steel bed, said system comprising:
a baseplate defining a plurality of openings configured to be aligned with the mounting holes in the steel bed;
a receiver tube presenting proximal and distal ends, said proximal end being rigidly coupled to the baseplate, said receiver tube defining a receiver channel extending inwardly from the distal end;
a first pintle hook and hitch ball assembly including a first coupling member of a first configuration and a first attachment bar adapted to be slidably and snugly received in the receiver channel;
a second pintle hook and hitch ball assembly including a second coupling member of a second configuration and a second attachment bar adapted to be slidably and snugly received in the receiver channel; and
an elongated pin,
said system being shiftable between a first position wherein the first attachment bar is secured to the receiver tube with the pin and a second position wherein the second attachment bar is secured to the receiver tube with the pin.

2. The tow connection system according to claim 1,
said first attachment bar being received in the receiver channel when the system is in the first position,
said second attachment bar being received in the receiver channel when the system is in the second position.

3. The tow connection system according to claim 2,
said receiver tube defining a receiver hole,
said first attachment bar defining a first attachment opening,
said second attachment bar defining a second attachment opening,
said receiver hole and said first attachment opening being substantially aligned when the system is in the first position,
said receiver hole and said second attachment opening being substantially aligned when the system is in the second position.

4. The tow connection system according to claim 3,
said pin being received in the receiver hole and the first attachment opening when the system is in the first position,
said pin being received in the receiver hole and the second attachment opening when the system is in the second position.

5. The tow connection system according to claim 4,
said pin including an elongated cylindrical main body presenting first and second ends, a fixed collar rigidly coupled to the first end, and a removable collar removably coupleable to the second end,
said pin being shiftable between a locked position wherein the removable collar is coupled to the second end and an unlocked position wherein the removable collar is decoupled from a second end,
said pin being in the locked position when the system is in the first and second positions.

6. The tow connection system according to claim 1,
said first coupling member including a first hitch ball of a first diameter,
said second coupling member including a second hitch ball of a second diameter substantially different from the first diameter.

7. The tow connection system according to claim 1; and
a plurality of gussets rigidly coupled to the baseplate and rigidly coupled to the receiver tube proximate the proximal end.

8. An apparatus comprising:
a vehicle having a steel bed, said steel bed presenting a substantially vertical rear face defining at least four mounting holes;
a mounting assembly including a baseplate, a receiver tube, and at least four bolts, said baseplate defining at least four baseplate holes aligned with said at least four mounting holes, each of said bolts extending through a respective aligned mounting hole and baseplate hole and rigidly coupling the mounting assembly to the rear face of the steel bed, said receiver tube including a proximal end rigidly coupled to the baseplate and a distal end spaced from the baseplate, said receiver tube defining a receiver channel extending inwardly from the distal end;
a first pintle hook and hitch ball assembly including a first coupling member and a first attachment bar adapted to be slidably and snugly received in the receiver channel; and
an elongated locking pin,
said first pintle hook and hitch ball assembly being shiftable between a first decoupled position wherein the first pintle hook and hitch ball assembly is decoupled from the mounting assembly and a first coupled position wherein the first attachment bar is received in the receiver channel and the locking pin extends through the receiver tube and the first attachment bar.

9. The apparatus according to claim 8; and
a second pintle hook and hitch ball assembly including a second coupling member and a second attachment bar adapted to be slidably and snugly received in the receiver channel,
said second pintle hook and hitch ball assembly being shiftable between a second decoupled position wherein the second pintle hook and hitch ball assembly is decoupled from the mounting assembly and a second coupled position wherein the second attachment bar is received in the receiver channel and the locking pin extends through the receiver tube and the second attachment bar.

10. The apparatus according to claim 9,
said apparatus being shiftable between a first configuration wherein the first pintle hook and hitch ball assembly is in the first coupled position and a second configuration wherein the second pintle hook and hitch ball assembly is in the second coupled position.

11. The apparatus according to claim 10,
said receiver tube defining a receiver hole,
said first attachment bar defining a first attachment opening,
said second attachment bar defining a second attachment opening,
said receiver hole and said first attachment opening being substantially aligned when the apparatus is in the first configuration,
said receiver hole and said second attachment opening being substantially aligned when the apparatus is in the second configuration.

12. The apparatus according to claim 11,
said pin being received in the receiver hole and the first attachment opening when the apparatus is in the first configuration,
said pin being received in the receiver hole and the second attachment opening when the apparatus is in the second configuration.

13. The apparatus according to claim 12,
said pin including an elongated cylindrical main body presenting first and second ends, a fixed collar rigidly coupled to the first end, and a removable collar removably coupleable to the second end,
said pin being shiftable between a locked position wherein the removable collar is coupled to the second end and an unlocked position wherein the removable collar is decoupled from the second end,
said pin being in the locked position when the apparatus is in the first and second configurations.

14. The apparatus according to claim 13,
said first coupling assembly including a first hitch ball of a first diameter,
said second coupling assembly including a second hitch ball of a second diameter substantially different from the first diameter.

15. A method of changing pintle hook and hitch ball assemblies on a vehicle,
said method comprising the steps of:
(a) removing a first pintle hook and hitch ball assembly from a receiver tube rigidly coupled to a steel bed of the vehicle;
(b) inserting a second pintle hook and hitch ball assembly into the receiver tube; and
(c) extending a pin through the second pintle hook and hitch ball assembly and the receiver tube, thereby securing the second pintle hook and hitch ball assembly in the receiver tube.

16. The method according to claim 15; and
(d) prior to step (a), coupling a mounting assembly to a steel bed of the vehicle,
said mounting assembly including a substantially flat baseplate and the receiver tube, said receiver tube extending generally perpendicular to the baseplate.

17. The method according to claim 16,
step (d) including extending a plurality of bolts through a plurality of holes in the baseplate and a corresponding plurality of holes in a generally vertical rear face of the steel bed.

18. The method according to claim 15,
step (b) including sliding a second attachment bar of the second pintle hook and hitch ball assembly into a receiver channel of the receiver tube until a second attachment hole of the second attachment bar is aligned with receiver holes in the receiver tube,
step (c) including extending the pin through the second attachment hole and the receiver holes.

19. The method according to claim 18; and
(e) subsequent to step (c), locking the receiver pin in the second attachment hole and the receiver holes to thereby prevent unauthorized removal of the pin from the receiver tube and the second attachment bar; and
(f) prior to step (a), removing the receiver pin from the receiver tube and the first pintle hook and hitch ball assembly.

20. The method according to claim 15,
said first pintle hook and hitch ball assembly including a first attachment bar configured to be received in the receiver tube and a first hitch ball of a first diameter,
said second pintle hook and hitch ball assembly including a second attachment bar configured to be received in the receiver tube and a second hitch ball of a second diameter substantially different from the first diameter.
